(19) United States
(12) Patent Application Publication
(10) Pub. No.: US 2006/0237032 A1
(43) Pub. Date: Oct. 26, 2006

(54) Cleaning method for semiconductor elements

(76) Inventor: Ming-Te Cheng, Taoyuan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/112,199

(22) Filed: Apr. 22, 2005

(51) Int. Cl. C23G 1/00; B08B 3/00

(52) U.S. Cl. 134/2; 134/34

(57) ABSTRACT

A method for cleaning semiconductor elements includes steps of positioning the semiconductor elements; washing the semiconductor elements by high-pressure water steam or solvent steam from front, top and rear sides to blow out soldering flux or oil residue; and repeating washing by steam two or three times. As the steam molecules are small, the semiconductor elements can be cleaned thoroughly by the steam. The temperature of the steam is relatively low, so the semiconductor elements will not be damaged.

### BACKGROUND OF THE INVENTION

1. Field of the Invention

The present invention relates to a cleaning method for semiconductor elements, and more particularly to a method to clean soldering flux or oil residue from a wafer or a flip-chip substrate.

2. Description of Related Art

With miniaturization of the semiconductor elements, an electric chip can not be soldered on a substrate by using a conventional method. Thus, a surface mounting technology (SMT) is used for soldering the electric chip on the substrate.

The SMT is also called the Flip-Chip method because the chip with bumps or tin balls is flipped to solder on the substrate in a face-down status.

During soldering, soldering flux is used to remove oxide or oil residue on soldered dots of the substrate or bumps of the chip, and then the bumps and soldered dots can be in a good connection after soldering. The soldering flux generally includes a water-soluble type and an oil-soluble type. A little soldering flux or oil residue will remain on the substrate after soldering, which may be harmful for signal transmission in the electric elements, so the soldering flux or oil residue should be removed.

For the water-soluble type soldering flux, water can be directly used; for the oil-soluble type soldering flux, a special solvent is used. However, gaps between the chip and the substrate or gaps between bumps of the wafer are so small that the soldering flux and oil residue in these gaps can not be effectively removed by simply using water or special solvent.

Another way to remove the soldering flux and oil residue is to use ultrasonic vibrations. Although using ultrasonic vibrations can effectively clean the chip and substrate, the chip may be harmed and aging quickly.

Therefore, the invention provides a cleaning method to mitigate or obviate the aforementioned problems.

### SUMMARY OF THE INVENTION

The main objective of the present invention is to provide a cleaning method which is used to remove soldering flux or oil residue from a flip-chip substrate.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a flip-chip substrate being washed by steam from a front side in according with the present invention;

FIG. 2 is a schematic view of the flip-chip substrate being washed by steam from a top side in accordance with the present invention; and

FIG. 3 is a schematic view of the flip-chip substrate being washed by steam from a rear side in accordance with the present invention.

### DETAILED DESCRIPTION OF THE PREFERRED EMBODIMENT

A cleaning method for semiconductor elements according to the present invention includes steps of:

Positioning the semiconductor elements: a wafer or a flip-chip substrate is positioned on a conveyor;

Washing the semiconductor elements by steam: high-pressure water steam or solvent steam is sprayed out from a nozzle to blow out soldering flux and oil residue occurring between a chip and the substrate, wherein the steam is blown in turn at front, top, and rear sides of the flip-chip substrate; and

Repeating washing by steam two or three times.

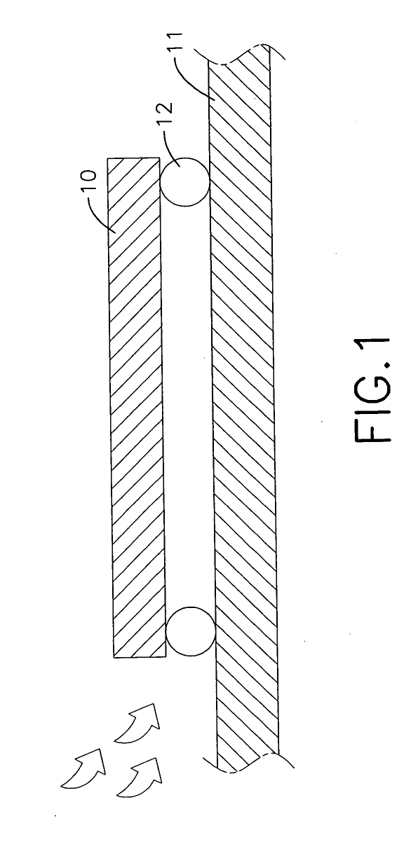

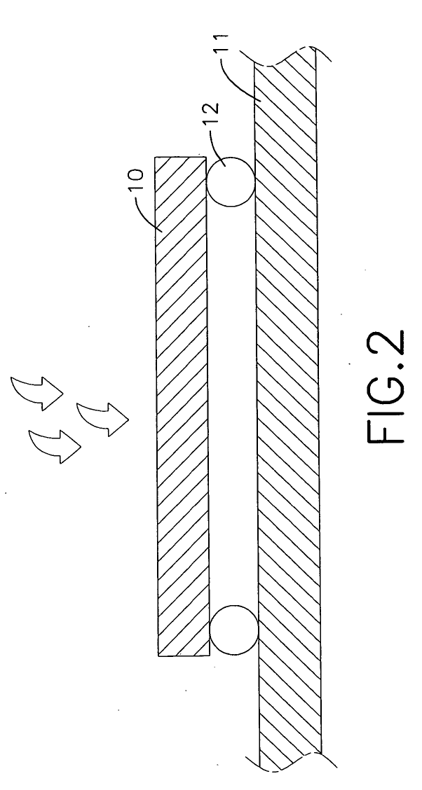

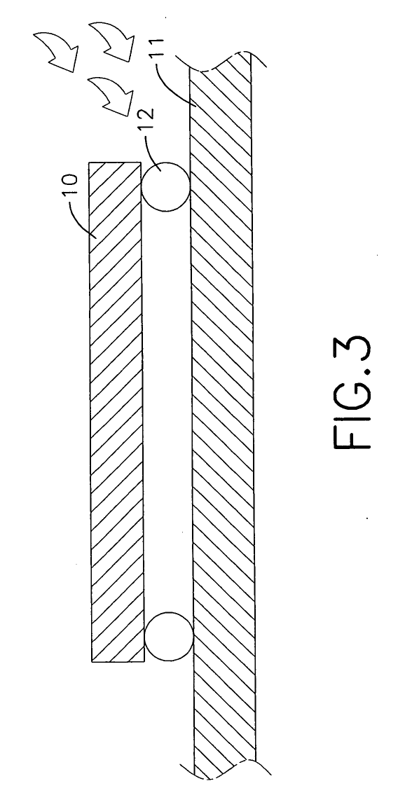

With reference to FIG. 1, the flip-chip substrate has a chip (10) mounted on a substrate (11). Multiple bumps or tin balls (12) are soldered between the chip (10) and the substrate (11), so a gap (not numbered) is defined between the chip (10) and the substrate (11). During washing, steam molecules can easily pass through the gap to blow out the soldering flux or oil residue. The steam is first blown from a front side of the substrate into the gap. Thereafter, the steam is blown from a top side of the substrate (11), as shown in FIG. 2, and blown from a rear side of the substrate (11), as shown in FIG. 3. Repeating the processing mentioned above, the soldering flux or oil residue can be removed completely.

Because the melting point of the soldering material for the chip is about 210-260° C. higher the boiling point of the steam i.e., about 100° C., the chip will not be damaged by the steam.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cleaning method for semiconductor elements comprising steps of
positioning the semiconductor elements;
washing the semiconductor elements by blowing steam in the semiconductor elements; and
repeating washing two or three times.

2. The cleaning method as claimed in claim 1, wherein the semiconductor elements include a flip-chip substrate.

3. The cleaning method as claimed in claim 1, wherein the semiconductor elements include a wafer.

4. The cleaning method as claimed in claim 1, wherein the semiconductor elements are positioned on a conveyor.

5. The cleaning method as claimed in claim 1, wherein the steam is blown in turn from front, top and rear sides of the semiconductor elements.

6. The cleaning method as claimed in claim 1, wherein the steam is water steam.

7. The cleaning method as claimed in claim 1, wherein the steam is solvent steam.
